(19) United States
(12) Patent Application Publication
(10) Pub. No.: US 2025/0100352 A1
(43) Pub. Date: Mar. 27, 2025

(54) VENT SYSTEM FOR VEHICLE INTERIOR

(71) Applicant: GM Global Technology Operations LLC, Detroit, MI (US)

(72) Inventors: Angel R. Munoz, Rochester Hills, MI (US); Eleodoro Pacheco, JR., Eastpointe, MI (US); Steven Jay Leathorn, Fort Gratiot, MI (US); Estephany Andrea Osorio, Tlaxcala (MX); Keith A. Fisher, Rochester, MI (US); Michael Giang, Sterling Heights, MI (US); Scott Stempek, Kalamazoo, MI (US); Steven Boyea, Marshall, MI (US); Bill Morrison, Kalamazoo, MI (US)

(73) Assignee: GM Global Technology Operations LLC, Detroit, MI (US)

(21) Appl. No.: 18/473,924

(22) Filed: Sep. 25, 2023

(51) Int. Cl. B60H 1/26; B60H 1/24

(52) U.S. Cl. CPC B60H 1/26; B60H 1/242

(57) ABSTRACT

A vent system for a motor vehicle includes a vent conduit defining a vent conduit inlet. A vent outlet is separated from the vent conduit inlet. A first vent channel includes a first vent channel inlet in fluid communication with the vent conduit inlet and a first channel nozzle defining a first fluid flow path to the vent outlet along a first direction. A second vent channel includes a second channel inlet in fluid communication with the vent conduit inlet and a second channel nozzle defining a second fluid flow path to the vent outlet along a second direction convergent with the first direction.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a vent system for a vehicle interior. Vehicle climate control systems typically include an air-handling unit and a plurality of vents for delivering air to a passenger compartment of the vehicle. Vents may be present within a dash panel or other areas of the passenger compartment, such as headboards, door panels, or vehicle consoles. Vents generally include one or more vanes and corresponding actuators that can be accessed by the passenger of the vehicle to manipulate the direction of airflow. Such vanes and actuators are typically exposed within the vehicle passenger compartment to allow easy access and control by the passenger.

### SUMMARY

An aspect of the disclosure provides a vent system for a motor vehicle. The vent system includes a vent conduit defining a vent conduit inlet and a vent outlet separated from the vent conduit inlet. The vent system further includes a first vent channel including a first vent channel inlet in fluid communication with the vent conduit inlet and a first channel nozzle defining a first fluid flow path to the vent outlet along a first direction. The vent system further includes a second vent channel including a second vent channel inlet in fluid communication with the vent conduit inlet and a second channel nozzle defining a second fluid flow path to the vent outlet along a second direction convergent with the first direction.

Aspects of the disclosure may include one or more of the following optional features. In some examples, the vent system further includes a primary flap disposed in the vent conduit inlet and configured to selectively obstruct the first vent channel inlet or the second vent channel inlet. In some examples, the first vent channel and the second vent channel are each at least partially defined by a separator panel disposed between the primary flap and the vent outlet.

In some configurations, the vent system further includes a first secondary vane disposed in the first vent channel and a second secondary vane disposed in the second vent channel, each of the first secondary vane and the second secondary vane configured to selectively rotate to direct a flow of air in a lateral direction. In some examples, the first secondary vane and the second secondary vane are recessed from the vent outlet.

In some examples, a height of at least one of the first vent channel and the second vent channel tapers along the direction from the vent conduit inlet to the vent outlet. In some implementations, the first vent channel extends along a first arcuate path and the second vent channel extends along a second arcuate path. In some configurations, the first channel nozzle includes a first nozzle outlet defining a first nozzle axis and the second channel nozzle includes a second nozzle outlet defining a second nozzle axis that converges with the first nozzle axis. In some examples, the first nozzle outlet is disposed adjacent to the second nozzle outlet at the vent outlet. In some implementations, the first nozzle outlet is separated from the second nozzle outlet at the vent outlet.

Another aspect of the disclosure provides a dash panel for a motor vehicle. The dash panel includes an upper dash panel, a lower dash panel spaced apart from the upper dash panel, and a vent outlet disposed between the upper dash panel and the lower dash panel. The dash panel further includes a vent system disposed within the dash panel and in communication with the vent outlet. The vent system includes a vent conduit inlet, a vent conduit including a first vent channel including a first vent channel inlet in fluid communication with the vent conduit inlet and a first channel nozzle defining a first fluid flow path to the vent outlet along a first direction, and a second vent channel including a second vent channel inlet in fluid communication with the vent conduit inlet and a second channel nozzle defining a second fluid flow path to the vent outlet along a second direction convergent with the first direction.

Aspects of the disclosure may include one or more of the following optional features. In some examples, the vent system includes a primary flap disposed in the vent conduit inlet and configured to selectively obstruct the first vent channel inlet or the second vent channel inlet. In some implementations, the first vent channel and the second vent channel are each at least partially defined by a separator panel disposed between the primary flap and the vent outlet.

In some implementations, the vent system includes a first secondary vane disposed in the first vent channel and a second secondary vane disposed in the second vent channel, each of the first secondary vane and the second secondary vane configured to selectively rotate to direct a flow of air in a lateral direction. In some configurations, the first secondary vane and the second secondary vane are recessed from the vent outlet. In some examples, a height of at least one of the first vent channel and the second vent channel tapers along the direction from the vent conduit inlet to the vent outlet. In some examples, the first vent channel extends along a first arcuate path and the second vent channel extends along a second arcuate path.

In some implementations, the first channel nozzle includes a first nozzle outlet defining a first outlet axis and the second channel nozzle includes a second nozzle outlet defining a second outlet axis that converges with the first nozzle axis. In some configurations, the first nozzle outlet is disposed adjacent to the second nozzle outlet at the vent outlet. In some examples, the first nozzle outlet is separated from the second nozzle outlet at the vent outlet.

### BRIEF DESCRIPTION OF THE DRAWINGS

The drawings described herein are for illustrative purposes only of selected configurations and are not intended to limit the scope of the present disclosure.

FIG. 1 is a perspective view of an example of a vent system according to the principles of the present disclosure;

FIG. 2 is a cross-sectional elevation view of the vent system of FIG. 1, taken at Line 2-2 in FIG. 1:

FIG. 3 is a cross-sectional perspective view of the vent system of FIG. 1, taken at Line 2-2 in FIG. 1;

FIG. 4A is a partial cross-sectional perspective view of the vent system of FIG. 1, wherein the vent system is configured to direct a flow of air in a first configuration:

FIG. 4B is a partial cross-sectional perspective view of the vent system of FIG. 1, wherein the vent system is configured to direct a flow of air in a second configuration:

FIG. 4C is a partial cross-sectional perspective view of the vent system of FIG. 1, wherein the vent system is configured to direct a flow of air in a third configuration:

FIG. 5 is a perspective view of another example of a vent system according to the principles of the present disclosure:

FIG. 6 is a cross-sectional elevation view of the vent system of FIG. 5, taken at Line 6-6 in FIG. 5:

FIG. 7 is a cross-sectional perspective view of the vent system of FIG. 5, taken at Line 6-6 in FIG. 5:

FIG. 8A is a partial cross-sectional perspective view of the vent system of FIG. 5, wherein the vent system is configured to direct a flow of air in a first configuration:

FIG. 8B is a partial cross-sectional perspective view of the vent system of FIG. 5, wherein the vent system is configured to direct a flow of air in a second configuration; and

FIG. 8C is a partial cross-sectional perspective view of the vent system of FIG. 5, wherein the vent system is configured to direct a flow of air in a third configuration.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second,” and other numerical terms do not imply a sequence or order unless clearly indicated by the context. Thus, a first element, component, region, layer or section discussed below could be termed a second element, component, region, layer or section without departing from the teachings of the example configurations.

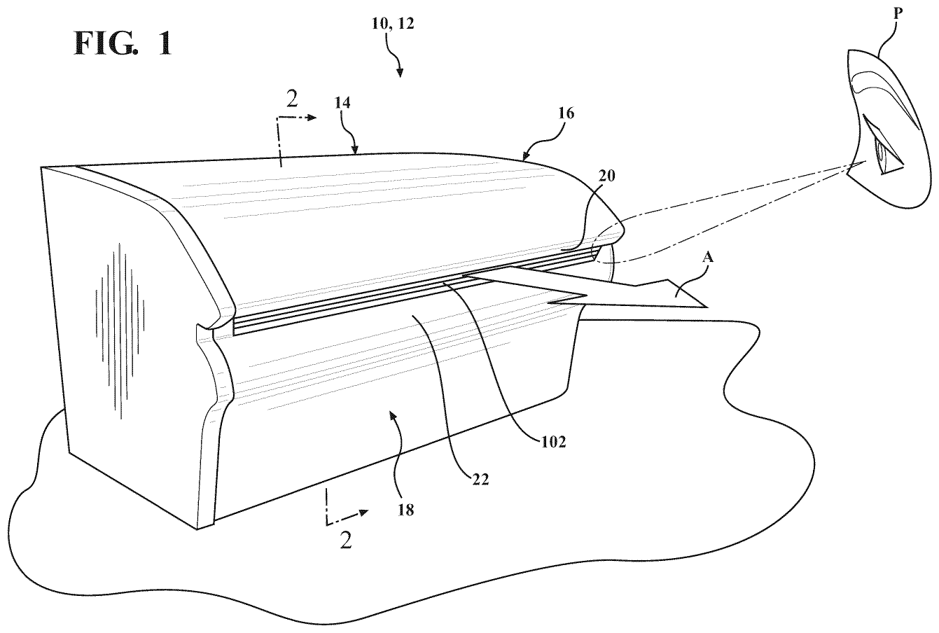

Referring to FIGS. 1-5, a first example of a vent system 100 according to the present disclosure is provided. As shown, the vent system 100 is incorporated within a dash panel 14 of a vehicle passenger compartment 12. Particularly, the vent system 100 may be integrated within the dash panel 14 between an upper dash panel 16 and a lower dash panel 18. Generally, the vent system 100 of the illustrated example is configured to minimize visibility of the vent system 100 to a passenger seated within the vehicle passenger compartment 12. Thus, components of the vent system 100 are recessed within the dash panel 14 relative to the passenger compartment 12. For instance, in the illustrated example, the vent system 100 includes a vent outlet 102 integrated into the dash panel 14 between a distal end 20 of the upper dash panel 16 and a distal end 22 of the lower dash panel 18. The vent outlet 102 is provided as an elongate channel extending continuously along the dash panel 14.

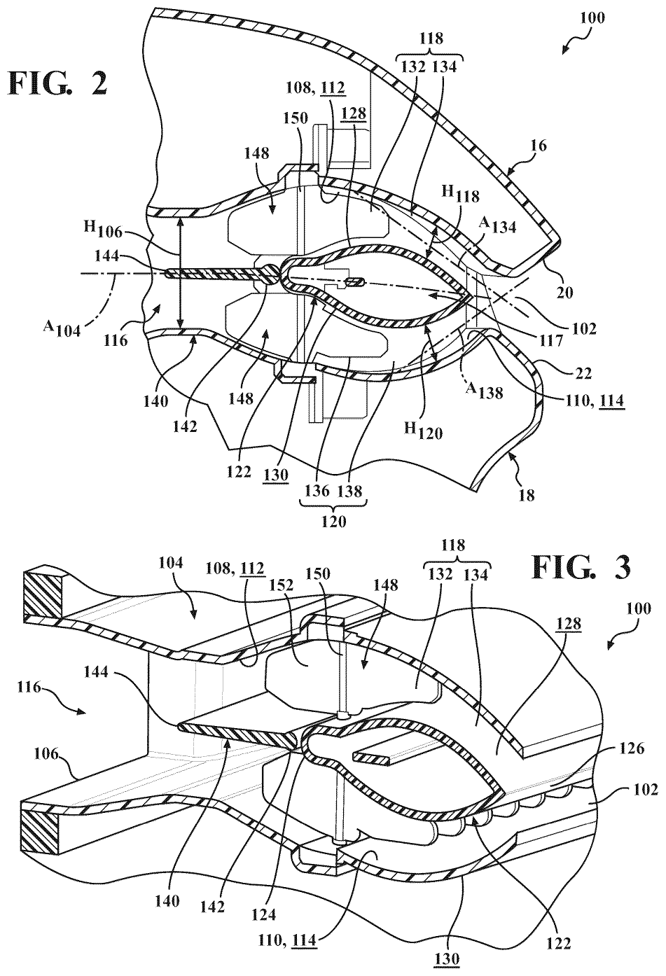

Referring to FIGS. 2 and 3, cross sectional views of the dash panel 14 illustrate the internal components of the vent system 100, which are generally recessed from the vent outlet 102 such that the internal components of the vent system 100 are not visible to a vehicle passenger P seated within the passenger compartment 12. The vent system 100 includes a vent conduit 104 configured to provide a fluid passageway 106 from a climate control system (not shown) of the vehicle 10 to the vent outlet 102. As shown, the vent conduit 104 includes a top vent conduit panel 108 and a bottom vent conduit panel 110 spaced apart from the top vent conduit panel 108 to define a height H₁₀₆ of the passageway 106. While not illustrated, the vent conduit 104 further includes a pair of side conduit panels each extending from the top vent conduit panel 108 and the bottom vent conduit panel 110. The top vent conduit panel 108 includes a top vent conduit surface 112 and the bottom vent conduit panel 110 includes a bottom vent conduit surface 114 that faces and is spaced apart from the top vent conduit surface 112 along a longitudinal axis A₁₀₄ of the vent conduit 104 to define the height H₁₀₆ of the passageway 106. A length of the vent conduit 104 may be described as extending along the longitudinal axis A₁₀₄ from a vent conduit inlet 116 to the vent outlet 102. The vent conduit inlet 116 is disposed at a first end of the vent conduit 104 and is configured to interface and communicate with the climate control system of the vehicle 10.

The vent conduit 104 further includes an intermediate portion or a vent cavity 117 disposed between the vent conduit inlet 116 and the vent outlet 102. In the illustrated example, the vent cavity 117 is disposed adjacent to the vent outlet 102 and defines a pair of vent channels 118, 120 providing parallel fluid flow paths from the vent conduit inlet 116 to the vent outlet 102 along a direction of the longitudinal axis A₁₀₄. The vent cavity 117 includes a vent cavity separator 122 disposed between the top vent conduit panel 108 and the bottom vent conduit panel 110. A length of the vent cavity separator 122 extends along the longitudinal axis A₁₀₄ from a first end 124 at the vent conduit inlet 116 to a second end 126 at the vent outlet 102. The vent cavity separator 122 includes an upper separator surface 128 extending from the first end 124 to the second end 126 and an opposite lower separator surface 130 formed on an opposite side from the upper separator surface 128. A distance from the upper separator surface 128 to the lower separator surface 130 defines a height of the vent cavity separator 122.

Referring still to FIG. 2, the vent cavity 117 and the vent cavity separator 122 cooperate to define an upper vent channel 118 and a lower vent channel 120. Particularly, the upper separator surface 128 opposes (i.e., faces) and is spaced apart from the top vent conduit surface 112 defined by the top vent conduit panel 108 to define the upper vent channel 118 providing fluid communication from the vent conduit inlet 116 to the vent outlet 102. Likewise, the lower separator surface 130 opposes (i.e., faces) and is spaced apart from the bottom vent conduit surface 114 defined by the bottom vent conduit panel 110 to define a lower vent channel 120 providing fluid communication from the vent conduit inlet 116 to the vent outlet 102.

In the illustrated example, the vent cavity surfaces 112, 114, 128, 130 provide the vent channels 118, 120 with arcuate profiles. For example, the top vent conduit surface 112 and the opposing bottom vent conduit surface 114 each have a concave curvature extending between the vent conduit inlet 116 and the vent outlet 102 while the upper vent separator surface 128 and the lower separator surface 130 each have a convex curvature extending between the first end 124 of the vent cavity separator 122 and the second end 126 of the vent cavity separator 122. Thus, the upper vent channel 118 follows an arcuate path having a concave curvature relative to the longitudinal axis A₁₀₄ of the vent conduit 104 while the lower vent channel 120 follows an arcuate path having an opposite concave curvature relative to the longitudinal axis A₁₀₄, whereby the upper vent channel 118 and the lower vent channel 120 initially diverge from each other from the vent conduit inlet 116 and then converge toward each other at the vent outlet 102. In this particular example, the vent channels 118, 120 converge with each other at the vent outlet 102. In other words, the second end 126 of the vent cavity separator 122 forms a point at the vent outlet 102 where the upper vent channel 118 and the lower vent channel 120 intersect.

Referring still to FIG. 2, each of the upper vent channel 118 and the lower vent channel 120 includes a vent channel inlet 132, 136 and a vent channel nozzle 134, 138. Particularly, the upper vent channel 118 includes an upper vent channel inlet 132 extending from the vent conduit inlet 116 and an upper vent channel nozzle 134 extending from the upper vent channel inlet 132 to the vent outlet 102. Likewise, the lower vent channel 120 includes a lower channel inlet 136 extending from the vent conduit inlet 116 and a lower vent channel nozzle 138 extending from the lower vent channel inlet 136 to the vent outlet 102. The vent channel inlets 132, 136 correspond to the aforementioned portions of the vent channels 118, 120 that diverge from each other while the vent channel nozzles correspond to the portions of the vent channels 118, 120 that converge toward each other. Thus, each of the vent channel nozzles 134, 138 defines respective vent nozzle axes A₁₃₄, A₁₃₈ that converge with each other along a direction of the longitudinal axis A₁₀₄ towards the vent outlet 102.

As best shown in FIG. 2, the vent conduit separator 122 is offset within the vent cavity 117 towards the vent outlet 102 along a direction of the longitudinal axis A₁₀₄. The offset configuration provides each of the upper vent channel 118 and the lower vent channel 120 with a tapering height H₁₁₈, H₁₂₀ from the vent conduit inlet 116 to the vent outlet 102. Particularly, the heights H₁₁₈, H₁₂₀ of the vent channels 118, 120 taper along the upper vent channel nozzle 134 and the lower vent channel nozzle 138, which results in an increased velocity of the airflow A at the vent outlet 102.

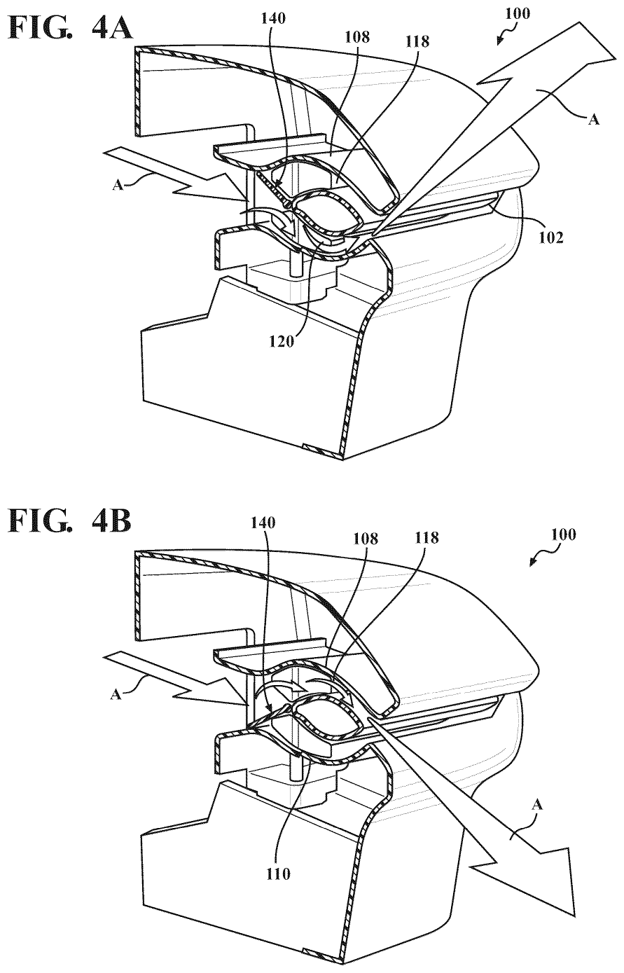

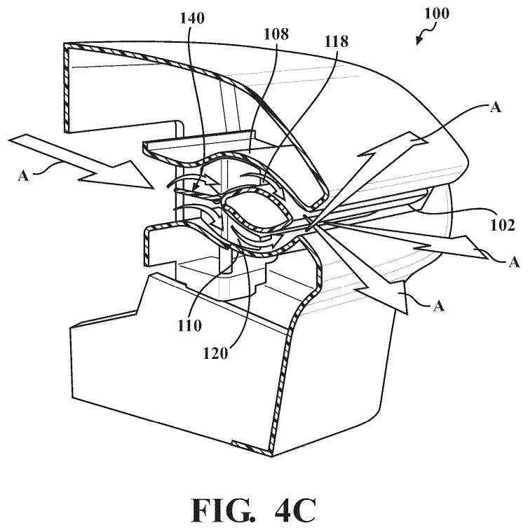

With continued reference to FIGS. 2 and 3, the vent system 100 includes a primary vane or flap 140 disposed within the vent conduit inlet 116 at the first end 124 of the vent cavity separator 122. The primary vane 140 is configured to selectively permit the flow of air A to enter the upper vent channel 118 and/or the lower vent conduit channel 120. The primary vane 140 includes a first end 142 pivotally attached to the vent conduit 104 adjacent to the first end 124 of the vent cavity separator 122. A length of the primary flap 140 extends from the first end 142 to a distal second end 144 disposed within the vent conduit inlet 116. The primary vane 140 is configured such that the second end 144 pivots or rotates about the first end 142 to move between an “up” position (FIG. 4A) and a “down” position (FIG. 4B). In the up position, the distal end 144 contacts the top vent conduit surface 112 in the vent conduit inlet 116 to block the flow of air A from entering the upper vent channel 118. Conversely, in the down position, the distal end 144 contacts the bottom vent conduit surface 114 to block the flow of air A to the lower vent channel 120. As discussed below, the primary vane 140 may also move to intermediate positions (FIG. 4C) to proportionally control the flow of air A into both of the upper vent channel 118 and the lower vent channel 120.

In addition to the primary vane 140, the vent system 100 includes a pair of secondary vanes 148 respectively disposed in each of the upper vent channel 118 and the lower vent channel 120. The secondary vanes 148 include a series of secondary vane flaps 152 each attached to a respective secondary vane pivot 150, whereby the secondary vane flaps 152 are configured to selectively direct the flow of air A in a lateral direction through the upper and lower vent channels 118, 120. In other words, the secondary vane flaps 152 may be rotated from a neutral position (i.e., air flowing straight through the vent channels 118, 120 parallel to the longitudinal axis A₁₀₄) to a rotated position to direct air to the left or right relative to the vent outlet 102.

The vent system 100 may include a vent control system 160 including a primary vane motor configured to rotate the primary vane 140, a secondary vane motor configured to rotate the secondary vanes, and a vent control system including a controller (i.e., data processing hardware) and memory hardware for generating instructions for the primary vane motor and the secondary vane motor. In other words, the primary vane 140 and the secondary vanes 148 are configured to be manipulated using the motors, whereby no external actuators or controls are present within the vehicle interior. In some examples, the secondary vanes 148 may be controlled together by a single secondary vane motor. Alternatively, the secondary vanes 148 may be independently actuated.

Referring to FIGS. 4A-4C, example operations of the vent system 100 to control the direction of the flow of air A are illustrated. While FIGS. 4A-4C show three examples—up, down, and center—it should be appreciated that the primary vane 140 may be manipulated to any intermediate position to proportionally control the direction of the flow of air A. In FIG. 4A, the primary vane 140 is configured in the “up” position, whereby the distal end 144 of the primary vane 140 is rotated about the first end 142 and contacts the top vent conduit surface 112 to block the upper vent channel inlet 132, thereby directing the entire flow of air A to the lower vent channel inlet 136. As indicated by the directional arrows, the flow of air A follows the arcuate path of the lower vent channel 120 and is directed to the vent outlet 102 along the direction of the axis A₁₃₈ (FIG. 2) of the lower vent channel nozzle 138. Thus, as shown in FIG. 4A, the flow of air A exits the vent outlet 102 and flows in an upward direction associated with the head or face of the passenger P.

In FIG. 4B, the primary vane 140 is configured in the “down” position, whereby the distal end 144 of the primary vane 140 is rotated about the first end 142 and contacts the bottom vent conduit surface 114 to block the lower vent channel inlet 136, thereby directing the entire flow of air A to the upper vent channel inlet 132. As indicated by the directional arrows, the flow of air A follows the arcuate path of the upper vent channel 118 and is directed to the vent outlet 102 along the direction of the axis A₁₃₄ (FIG. 2) of the upper vent channel nozzle 134. Thus, as shown in FIG. 4B, the flow of air A exits the vent outlet 102 and flows in a downward direction associated with the lower body of the passenger P.

In FIG. 4C, the primary vane 140 is configured in the “neutral” position, whereby the distal end 144 of the primary vane 140 is rotated about the first end 142 and is centered between the upper vent conduit surface 112 and the bottom vent conduit surface 114, thereby splitting the entire flow of air A evenly between the upper vent channel inlet 132 and the lower vent channel inlet 136. As indicated by the directional arrows, the flow of air A follows the arcuate paths of each of the upper vent channel 118 and the lower vent channel 120 and is directed to the vent outlet 102 along the direction of the axes A₁₃₄, A₁₃₈ (FIG. 2) of the upper vent channel nozzle 134 and the lower vent channel nozzle 138, respectively. The upper and lower flows of air A converge at the vent outlet 102, whereby the upward direction of the flow of air A from the lower vent channel nozzle 138 combines with and counteracts the downward direction of the flow of air A from the upper vent channel nozzle 134. Thus, as shown in FIG. 4C, the flows of air A exits the vent outlet 102 in a horizontal direction associated with the torso of the passenger P. In use, the vertical direction of the flow of air A from the outlet can be adjusted by modulating the primary vane 140. For example, biasing the primary vane 140 towards the top vent conduit surface 112 will proportionally increase the volumetric flow rate to the lower vent channel inlet 136. The increased flow of air through the lower vent channel 120 will bias the outlet flow of air A upward as the forces associated with the greater flow of air A through the lower vent channel 120 overcome the forces associated with the lesser flow of air A through the upper vent channel 118.

As best shown in FIG. 2, the distal ends 20, 22 of the upper and lower dash panels define blunted surfaces that are substantially flat and oriented transverse to the nozzle axes A₁₃₄, A₁₃₈ to prevent the flow of air A from being influenced by the Coanda effect as the flow of air A exits the vent outlet 102. In the illustrated example, the distal ends 20, 22 are substantially perpendicular. However, in other configurations, the distal ends 20, 22 may be oriented at a greater angle relative to the nozzle axes A₁₃₄, A₁₃₈. Thus, the direction of the flow of air A from the vent outlet 102 is wholly controlled by modulating the flow air A through the vent channels 118, 120 and not by the exterior surfaces of the dash panel 14.

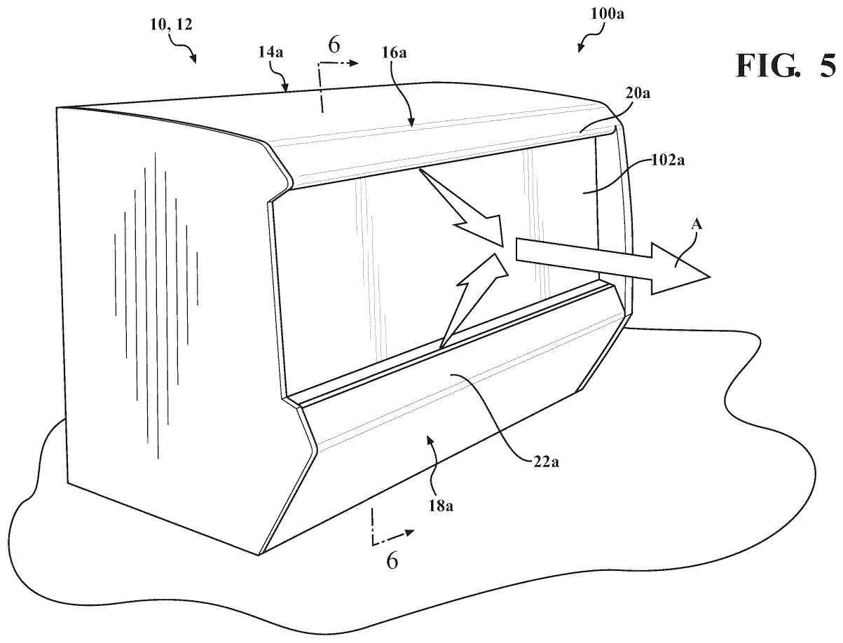

Referring to FIGS. 5-8C, the vent system 100a is incorporated within the dash panel 14 of the vehicle passenger compartment 12. Particularly, the vent system 100a may be integrated within a dash panel 14a between an upper dash panel 16a and a lower dash panel 18a. Generally, the vent system 100a of the illustrated example is configured to minimize visibility of the vent system 100a to a passenger seated within the vehicle passenger compartment 12. Thus, components of the vent system 100a are recessed within the dash panel 14a relative to the passenger compartment 12. For instance, in the illustrated example, the vent system 100a includes a vent outlet 102aa integrated into the dash panel 14 between the distal end 20a of the upper dash panel 16a and the distal end 22a of the lower dash panel 18a. The vent outlet 102a is provided as an elongate channel extending continuously along the dash panel 14a.

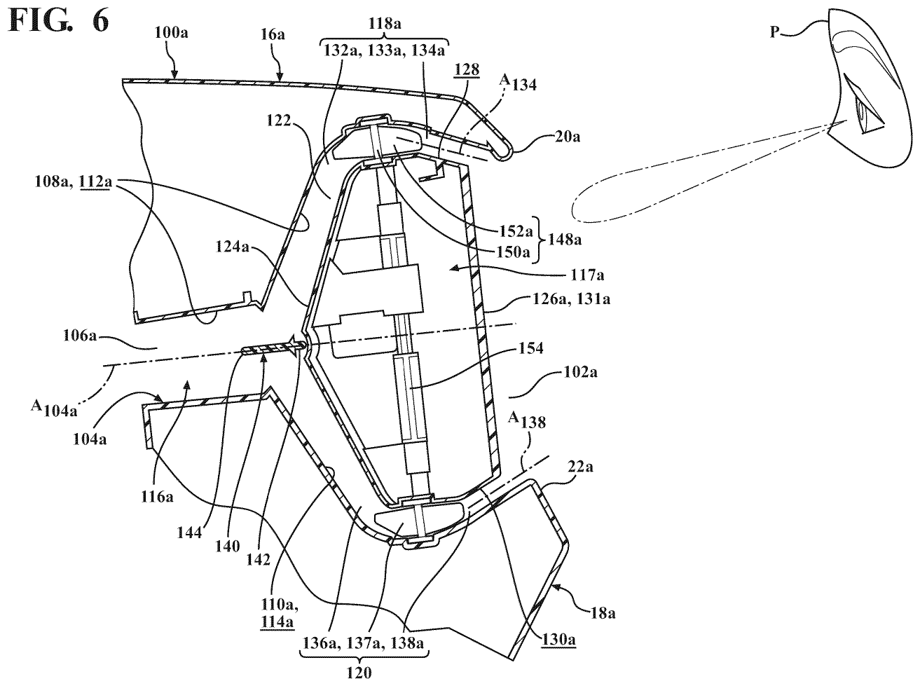

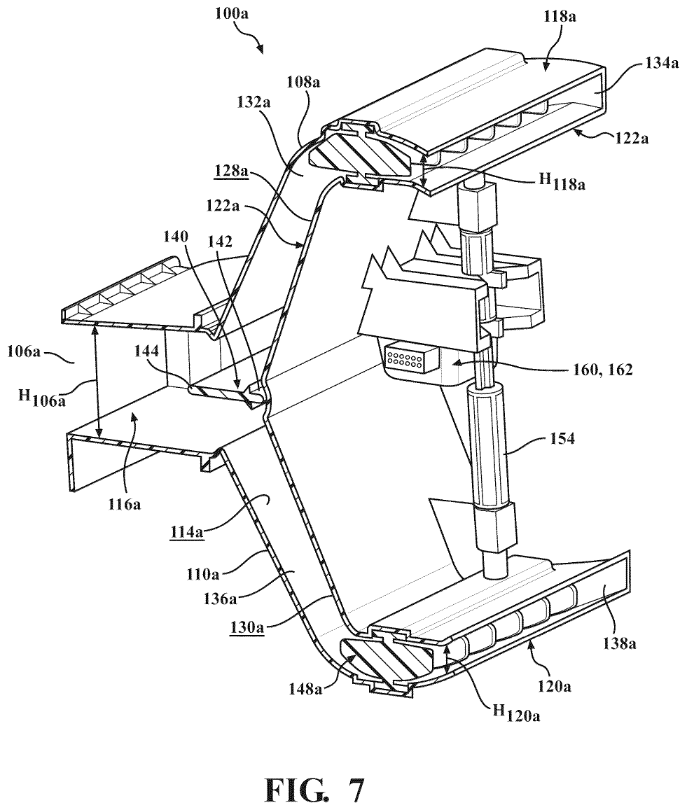

Referring to FIGS. 6 and 7, cross sectional views of the dash panel 14a illustrate the internal components of the vent system 100a, which are generally recessed from the vent outlet 102a such that the internal components of the vent system 100a are not visible to a vehicle passenger P seated within the passenger compartment 12. The vent system 100a includes a vent conduit 104a configured to provide a fluid passageway 106a from a climate control system 24 of the vehicle 10 to the vent outlet 102a. As shown, the vent conduit 104a includes a top vent conduit panel 108a and a bottom vent conduit panel 110a spaced apart from the top vent conduit panel 108 to define a height H₁₀₆ₐ of the passageway 106a. While not illustrated, the vent conduit 104a further includes a pair of side conduit panels each extending from the top vent conduit panel 108a and the bottom vent conduit panel 110a. The top vent conduit panel 108a includes a top vent conduit surface 112a and the bottom vent conduit panel 110a includes a bottom vent conduit surface 114a that faces and is spaced apart from the top vent conduit surface 112a along a longitudinal axis A₁₀₄ₐ of the vent conduit 104a to define the height H₁₀₆ₐ of the passageway 106a. A length of the vent conduit 104a may be described as extending along the longitudinal axis A₁₀₄ₐ from a vent conduit inlet 116a to the vent outlet 102a. The vent conduit inlet 116a is disposed at a first end of the vent conduit 104a and is configured to interface and communicate with the climate control system of the vehicle 10.

The vent conduit 104a further includes an intermediate portion or a vent cavity 117a disposed between the vent conduit inlet 116a and the vent outlet 102a. In the illustrated example, the vent cavity 117a is disposed adjacent to the vent outlet 102a and defines a pair of vent channels 118a, 120a providing parallel fluid flow paths from the vent conduit inlet 116a to the vent outlet 102a along a direction of the longitudinal axis A₁₀₄ₐ. The vent cavity 117a includes a vent cavity separator 122a disposed between the top vent conduit panel 108a and the bottom vent conduit panel 110a. A length of the vent cavity separator 122a extends along the longitudinal axis A₁₀₄ₐ from a first end 124a at the vent conduit inlet 116a to a second end 126a at the vent outlet 102a. The vent cavity separator 122a includes an upper separator surface 128a extending from the first end 124a to the second end 126a and an opposite lower separator surface 130a formed on an opposite side from the upper separator surface 128a. A distance from the upper separator surface 128a to the lower separator surface 130a defines a height H₁₂₂ₐ of the vent cavity separator 122a.

Referring still to FIG. 6, the vent cavity 117a and the vent cavity separator 122a cooperate to define an upper vent channel 118a and a lower vent channel 120a. Particularly, the upper separator surface 128a opposes (i.e., faces) and is spaced apart from the top vent conduit surface 112a defined by the top vent conduit panel 108a to define the upper vent channel 118a providing fluid communication from the vent conduit inlet 116a to the vent outlet 102a. Likewise, the lower separator surface 130a opposes (i.e., facing) and is spaced apart from the bottom vent conduit surface 114a defined by the bottom vent conduit panel 110a to define a lower vent channel 120a providing fluid communication from the vent conduit inlet 116a to the vent outlet 102a.

Referring still to FIG. 6, each of the upper vent channel 118a and the lower vent channel 120a includes a vent channel inlet 132a, 136a and a vent channel nozzle 134a, 138a. Particularly, the upper vent channel 118a includes an upper vent channel inlet 132a extending from the vent conduit inlet 116a and an upper vent channel nozzle 134a extending from the upper vent channel inlet 132a to the vent outlet 102a. Likewise, the lower vent channel 120a includes a lower channel inlet 136a extending from the vent conduit inlet 116a and a lower vent channel nozzle 138a extending from the lower vent channel inlet 136a to the vent outlet 102a. In this example, the upper vent channel nozzle 134a is separated or spaced apart from the lower vent channel nozzle 138a at the vent outlet 102a by a front separator panel 131a extending between the upper separator surface 128a and the lower separator surface 130a at the second end 126a of the vent cavity separator 122a. Optionally, the front separator panel 131a may include a graphical user interface or an electronic display screen integrated into the front separator panel 131a to provide a visual display and/or interface between the upper vent channel nozzle 134a and the lower vent channel nozzle 138a.

Similar to the example of the vent system 100 previously described, the vent channel inlets 132a, 136a diverge from each other while the vent channel nozzles 134a, 138a converge toward each other. In this example, the vent channels 118a. 120a have a segmented profile, whereby each of the vent channel inlets 132a. 136a are substantially straight first segments of the vent channel 118a, 120a that diverge from each other and the vent channel nozzles 134a. 138a are substantially straight second segments of the vent channels 118a. 120a that converge toward each other along the direction of the flow of air A. In the illustrated example, the vent channel inlets 132a. 136a are connected to the respective vent channel nozzles 134a, 138a by arcuate transition segments 133a, 137a, which each define a concave curvature facing the longitudinal axis A₁₀₄ₐ. As best shown in FIGS. 6 and 7, each of the upper channel 118a and the lower vent channel 120a may have a tapering height H₁₁₈ₐ, H₁₂₀ₐ from the vent conduit inlet 116a to the vent outlet 102a. Particularly, the heights H₁₁₈ₐ, H₁₂₀ₐ of the vent channels 118a. 120a taper along the upper vent channel inlet 132a and the lower vent channel inlet 136a, which results in an increased velocity of the airflow A at the vent outlet 102a.

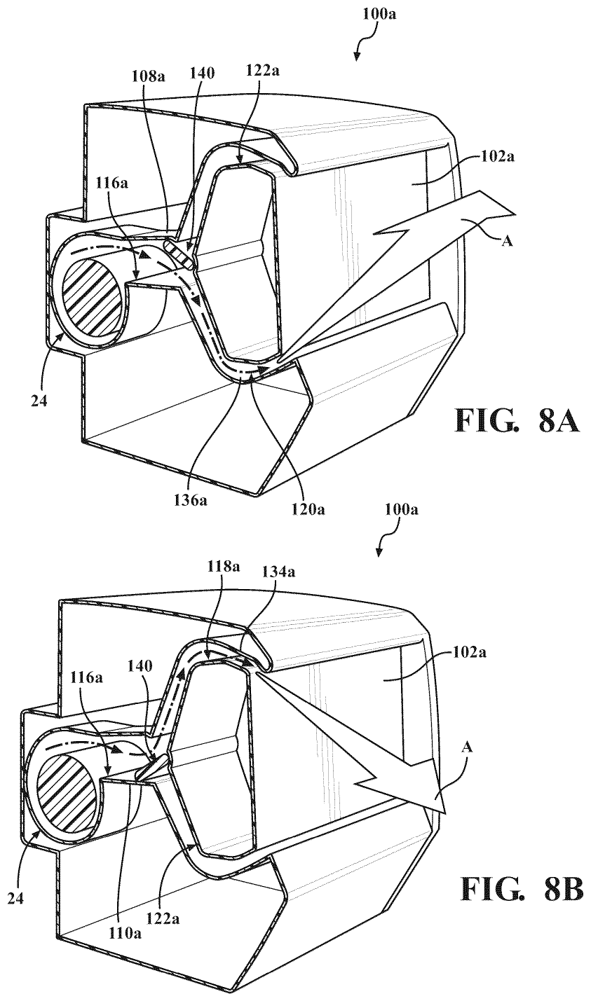

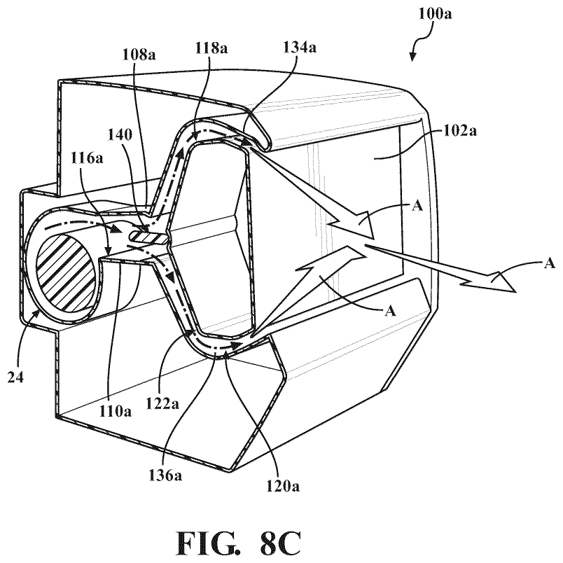

With continued reference to FIGS. 6 and 7, the vent system 100a includes the primary vane or flap 140 disposed within the vent conduit inlet 116a at the first end 124a of the vent cavity separator 122a. The primary vane 140 is configured to selectively permit the flow of air A to enter the upper vent channel 118a and/or the lower vent channel 120a. The primary vane 140 includes the first end 142 pivotally attached to the vent conduit 104a adjacent to the first end 124a of the vent cavity separator 122a. A length of the primary flap 140 extends from the first end 142 to the distal second end 144 disposed within the vent conduit inlet 116a. The primary vane 140 is configured such that the second end 144 pivots or rotates about the first end 142 to move between an “up” position (FIG. 8A) and a “down” position (FIG. 8B). In the up position, the distal end 144 contacts the top vent conduit surface 112a in the vent conduit inlet 116a to block the flow of air A from entering the upper vent channel 118a. Conversely, in the down position, the distal end 144 contacts the bottom vent conduit surface 114a to block the flow of air A to the lower vent channel 120a. As discussed below, the primary vane 140 may also move to intermediate positions to proportionally control the flow of air A into both of the upper vent channel 118a and the lower vent channel 120a.

In addition to the primary vane 140, the vent system 100a includes a pair of secondary vanes 148a respectively disposed in each of the upper vent channel 118a and the lower vent channel 120a. The secondary vanes 148a includes a series of secondary vane flaps 152a each attached to a respective secondary vane pivot 150a, whereby the secondary vane flaps 152a are configured to selectively direct the flow of air A in a lateral direction through the upper and lower vent channels 118a, 120a. In other words, the secondary vane flaps 152a may be rotated from a neutral position (i.e., air flowing straight through the vent channels 118a, 120a) to a rotated position to direct air to the left or right relative to the vent outlet 102a. In the illustrated example, the secondary vane pivots 150a are connect to each other by a common drive shaft 154, which may be controlled by a secondary vane motor.

The vent system 100a may include the vent control system 160 including a primary vane motor configured to rotate the primary vane 140, a secondary vane motor 162 configured to rotate the secondary vanes, and a vent control system including a controller (i.e., data processing hardware) and memory hardware for generating instructions for the primary vane motor and the secondary vane motor. In other words, the primary vane 140 and the secondary vanes 148a are configured to be manipulated using the motors, whereby no external actuators or controls are present within the vehicle interior.

Referring to FIGS. 8A-8C, example operations of the vent system 100a to control the direction of the flow of air A are illustrated. While FIGS. 8A-8C show three examples—up, down, and center—it should be appreciated that the primary vane 140 may be manipulated to any intermediate position to proportionally control the direction of the flow of air A. In FIG. 8A, the primary vane 140 is configured in the “up” position, whereby the distal end 144 of the primary vane 140 is rotated about the first end 142 and contacts the top vent conduit surface 112a to block the upper vent channel inlet 132a, thereby directing the entire flow of air A to the lower vent channel inlet 136a. As indicated by the directional arrows, the flow of air A follows the arcuate path of the lower vent channel 120a and is directed to the vent outlet 102a along the direction of the axis A₁₃₈ₐ (FIG. 6) of the lower vent channel nozzle 138a. Thus, as shown in FIG. 8A, the flow of air A exits the vent outlet 102a and flows in an upward direction associated with the head or face of the passenger P.

In FIG. 8B, the primary vane 140 is configured in the “down” position, whereby the distal end 144 of the primary vane 140 is rotated about the first end 142 and contacts the bottom vent conduit surface 114a to block the lower vent channel inlet 136a, thereby directing the entire flow of air A to the upper vent channel inlet 132a. As indicated by the directional arrows, the flow of air A follows the arcuate path of the upper vent channel 118a and is directed to the vent outlet 102a along the direction of the axis A₁₃₄ₐ (FIG. 6) of the upper vent channel nozzle 134a. Thus, as shown in FIG. 8B, the flow of air A exits the vent outlet 102a and flows in a downward direction associated with the lower body of the passenger P.

In FIG. 8C, the primary vane 140 is configured in the “neutral” position, whereby the distal end 144 of the primary vane 140 is rotated about the first end 142 is centered between the upper vent conduit surface 112a and the bottom vent conduit surface 114a thereby splitting the entire flow of air A evenly between the upper vent channel inlet 132a and the lower vent channel inlet 136a. As indicated by the directional arrows, the flow of air A follows the arcuate path of each of the upper vent channel 118a and the lower vent channel 120a and is directed to the vent outlet 102a along the direction of the axes A₁₃₄ₐ, A₁₃₈ₐ (FIG. 6) of the upper vent channel nozzle 134a and the lower vent channel nozzle 138a, respectively. The upper and lower flows of air A converge at the vent outlet 102a, whereby the upward direction of the flow of air A from the lower vent channel nozzle 138a combines with and counteracts the downward direction of the flow of air A from the upper vent channel nozzle 134a. Thus, as shown in FIG. 8C, the flow of air A exits the vent outlet 102a and flows in a horizontal direction associated with the torso of the passenger P. In use, the vertical direction of the flow of air A can be adjusted by modulating the primary vane 140. For example, biasing the primary vane 140 towards the top vent conduit surface 112a will proportionally increase the volumetric flow rate to the lower vent channel inlet 136a. The increased flow of air through the lower vent channel 120a will bias the outlet flow of air A upward as the forces associated with the greater flow of air A through the lower vent channel 120a overcome the forces associated with the lesser flow of air A through the upper vent channel 118a.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vent system for a motor vehicle, the vent system comprising:
a vent conduit defining a vent conduit inlet;
a vent outlet separated from the vent conduit inlet;
a first vent channel including a first vent channel inlet in fluid communication with the vent conduit inlet and a first channel nozzle defining a first fluid flow path to the vent outlet along a first direction; and
a second vent channel including a second vent channel inlet in fluid communication with the vent conduit inlet and a second channel nozzle defining a second fluid flow path to the vent outlet along a second direction convergent with the first direction.

2. The vent system of claim 1, further comprising a primary flap disposed in the vent conduit inlet and configured to selectively obstruct the first vent channel inlet or the second vent channel inlet.

3. The vent system of claim 2, wherein the first vent channel and the second vent channel are each at least partially defined by a separator panel disposed between the primary flap and the vent outlet.

4. The vent system of claim 2, further comprising a first secondary vane disposed in the first vent channel and a second secondary vane disposed in the second vent channel, each of the first secondary vane and the second secondary vane configured to selectively rotate to direct a flow of air in a lateral direction.

5. The vent system of claim 4, wherein the first secondary vane and the second secondary vane are recessed from the vent outlet.

6. The vent system of claim 1, wherein a height of at least one of the first vent channel and the second vent channel tapers along the direction from the vent conduit inlet to the vent outlet.

7. The vent system of claim 1, wherein the first vent channel extends along a first arcuate path and the second vent channel extends along a second arcuate path.

8. The vent system of claim 1, wherein the first channel nozzle includes a first nozzle outlet defining a first nozzle axis and the second channel nozzle includes a second nozzle outlet defining a second nozzle axis that converges with the first nozzle axis.

9. The vent system of claim 8, wherein the first nozzle outlet is disposed adjacent to the second nozzle outlet at the vent outlet.

10. The vent system of claim 8, wherein the first nozzle outlet is separated from the second nozzle outlet at the vent outlet.

11. A dash panel for a motor vehicle, the dash panel comprising:
an upper dash panel;
a lower dash panel spaced apart from the upper dash panel;
a vent outlet disposed between the upper dash panel and the lower dash panel; and
a vent system disposed between the upper dash panel and the lower dash panel and in communication with the vent outlet, the vent system including:
a vent conduit inlet;
a vent conduit including a first vent channel including a first vent channel inlet in fluid communication with the vent conduit inlet and a first channel nozzle defining a first fluid flow path to the vent outlet along a first direction; and
a second vent channel including a second vent channel inlet in fluid communication with the vent conduit inlet and a second channel nozzle defining a second fluid flow path to the vent outlet along a second direction convergent with the first direction.

12. The vent system of claim 11, further comprising a primary flap disposed in the vent conduit inlet and configured to selectively obstruct the first vent channel inlet or the second vent channel inlet.

13. The vent system of claim 12, wherein the first vent channel and the second vent channel are each at least partially defined by a separator panel disposed between the primary flap and the vent outlet.

14. The vent system of claim 12, further comprising a first secondary vane disposed in the first vent channel and a second secondary vane disposed in the second vent channel, each of the first secondary vane and the second secondary vane configured to selectively rotate to direct a flow of air in a lateral direction.

15. The vent system of claim 14, wherein the first secondary vane and the second secondary vane are recessed from the vent outlet.

16. The vent system of claim 11, wherein a height of at least one of the first vent channel and the second vent channel tapers along the direction from the vent conduit inlet to the vent outlet.

17. The vent system of claim 11, wherein the first vent channel extends along a first arcuate path and the second vent channel extends along a second arcuate path.

18. The vent system of claim 11, wherein the first channel nozzle includes a first nozzle outlet defining a first outlet axis and the second channel nozzle includes a second nozzle outlet defining a second outlet axis that converges with the first nozzle axis.

19. The vent system of claim 18, wherein the first nozzle outlet is disposed adjacent to the second nozzle outlet at the vent outlet.

20. The vent system of claim 18, wherein the first nozzle outlet is separated from the second nozzle outlet at the vent outlet.
